(19) United States
(12) Patent Application Publication
(10) Pub. No.: US 2010/0215936 A1
(43) Pub. Date: Aug. 26, 2010

(54) COATING FOR INHIBITING GLASS TO GLASS ADHERENCE

(76) Inventors: Joseph E. Canale, Corning, NY (US); Stephen B. Shay, Chatham, VA (US); Tinh V. Tran, Charlotte, NC (US)

Correspondence Address: CORNING INCORPORATED, SP-TI-3-1, CORNING, NY, 14831, US

(21) Appl. No.: 12/707,926

(22) Filed: Feb. 18, 2010

Related U.S. Application Data
(60) Provisional application No. 61/154,234, filed on Feb. 20, 2009.

(51) Int. Cl. B32B 5/16; B32B 5/00; C03C 17/00

(52) U.S. Cl. 428/220; 428/331; 65/60.8

(57) ABSTRACT

Cover slips having improved non-stick properties are provided and a method for making such cover slips is described. In one aspect the use of water-based, colloidal alkylpoly(alkoxy)silanes of formula [(R₁)ₓSi(OR₂)₄₋ₓ, where x=1-3, R₁ is a C₆-C₂₄ hydrocarbon (preferably an alkyl hydrocarbon) and R₂ is a C₁-C₃ hydrocarbon (preferably a C₁ hydrocarbon)] having a particle size in the range of 6-20 nm is described.

### CROSS-REFERENCE TO RELATED APPLICATIONS

This application claims the benefit of priority under 35 U.S.C. §119(e) of U.S. Provisional Application Ser. No. 61/154,234 filed on Feb. 20, 2009.

### FIELD

The invention is directed to a method for preventing thin glass sheets or articles from adhering to one another and to the thin, non-adherent sheets or articles produced by the method. In particular, the method is directed to producing glass cover slips for use in optical microscopy.

### BACKGROUND

Microscope cover slips are thin glass articles generally having a thickness in the range of 0.003-0.020 inch (0.08-0.5 mm), the most common thickness being about 0.006 inch (0.15 mm). However, when not coated with an anti-stick agent and stacked one on top of another these thin glass articles have tendency to stick to one another due to covalent bonding between opposing Si—OH groups on adjacent surfaces that forms a Si—O—Si bond between the two surfaces with the elimination of a molecule of water (H₂O). The tendency the cover slips to stick to one another makes it difficult to use the cover slips in automatic cover slip dispensing machines, Consequently, it is necessary to coat the cover clips with an anti-stick material.

Due to the intended use of the cover slips not all anti-stick materials are suitable for use, particularly when the cove slips are being used for the analysis of biological or pharmaceutical samples. Materials such as ammonium chloride and Lucor™ powder (U.S. Pat. No. 5,067,753) have been used to prevent glass surfaces from sticking to one another. While these materials have succeeded to a certain degree, there are still some drawbacks. In particular, the non-sticking behavior of these materials is temporary as dissipates over time. Temperature and humidity can quickly affect the coated surface and dissipate the non-sticking behavior of the coated cover slips to the point where they behave as if the coating was never applied. Consequently, it is highly desirable that an improved method of preventing cover slips from adhering to one another.

### SUMMARY

The present invention is directed to cover slips having improved non-stick properties and to a method for making such cover slips. In one aspect the invention is directed to the use of water-based, colloidal alkylpoly(alkoxy)silane [(R₁)ₓSi(OR₂)₄₋ₓ, where x=1-3, R₁ is a C₆-C₂₄ hydrocarbon (preferably an alkyl hydrocarbon) and R₂ is a C₁-C₃ hydrocarbon (preferably a C₁ hydrocarbon)] resin having a particle size in the range of 6-20 nm, preferably a particle size in the range of 6-15 nm; and to a method of making such cover slips. In another aspect the invention is directed to cover slips having a coating of Dow Corning 2-1322 (a proprietary colloidal methylpolyalkoxysilane resin having a particle size of approximately 10 nm) as the anti-stick material and to a method of making such cover slips.

In one embodiment the invention is directed to a method for making a coated, non-stick glass sheet, said method consisting of the steps:

preparing a potash, soda, zinc borosilicate glass mixture by combining potash, soda, zinc oxide and silica sand, and mixing same;

melting the batched material to form a glass melt; forming the glass melt into a continuous glass sheet having a selected length, width and thickness cooling the continuous sheet to ambient temperature; cutting the cooled continuous glass sheet into individual sheets;

coating the individual glass sheet with a selected colloidal alkylpoly(alkoxy)silane resin having a particle size in the range of 6-20 nm to thereby form a coated, non-stick glass sheet having a surface energy of less than 60 dynes/cm.

In another embodiment the invention is directed to a method for making a coated, non-stick glass cover slips, said method consisting of the steps:

preparing a potash, soda, zinc borosilicate glass mixture by combining potash, soda, zinc oxide and silica sand, and mixing same;

melting the batched material to form a glass melt;

forming the glass melt into a continuous glass sheet having a selected length, width and thickness

cooling the continuous sheet to a temperature in the range of 70-180° C. ambient temperature;

coating the continuous glass sheet with a selected colloidal alkylpoly(alkoxy)silane resin having a particle size in the range of 6-20 nm, while maintaining the temperature of the continuous glass sheet in the range of 70-180° C., to thereby form a coated, non-stick continuous glass sheet having a surface energy of less than 60 dynes/cm;

cooling the coated continuous glass sheet to ambient temperature;

cutting the cooled coated continuous glass sheet into individual sheets; and

cutting the individual glass sheets into individual cover slips of selected of selected length and width and thickness in the range of 0.076 mm to 0.60 mm.

### BRIEF DESCRIPTION OF THE DRAWINGS

FIG. 1 is an illustration of surface behavior of materials with different surface energy (in dynes/cm) on glass.

FIG. 2 is a SEM/EDX photograph of an ammonium chloride coated, commercially available cover slip glass surface and the approximately 1 μm NaCl particles present on the surface.

FIG. 3 is a SEM/EDX photograph of a commercially available coated cover slip glass surface with an organic residue on the surface and ˜20 nm nodules and the approximately 1 μm NaCl particles present on the surface.

FIG. 4 is a SEM/EDX photograph DC2-3122 coated surface.

### DETAILED DESCRIPTION

In general the process of making microscope cover slips (also called cover glasses) involves preparing a glass batch mix, melting the mix, drawing the glass to a selected width and thickness and annealing the drawn glass, coating the glass with a anti-stick coating material or agent, cutting the glass to form articles of a selected size (for example, cover slips), inspecting the articles and packing the inspected articles for sale and shipment. Ammonium chloride and Lucor powder have been used as anti-stick agents, but while these materials have succeeded to a certain degree, there are still some drawbacks. In particular, the non-sticking behavior of these materials is temporary and dissipates over time. Temperature and humidity can affect the coated surface and dissipate the non-sticking behavior of the coated cover slips to the point where they behave as if the coating was never applied. Cover slips treated with these materials are not trouble-free when used in automatic cover slip dispensing machines because, over time, the cover slips tend to stick together causing the dispensing machines to jam which can also result in glass breakage. Consequently, new anti-stick coating materials are desired that are easy to apply; produce low cover slip-to-slip friction; are stable and will not deteriorate over tine or in the presence of water or high humidity; are non-corrosive; are low cost; can be applied as an aqueous solution or suspension to cover slips or the glass sheets from the cover slips are made, and are not cytotoxic when used biological analyses.

The materials and methods described herein have been found to eliminate the sheet-to-sheet adhesion of glass used to make cover slips and the cover slips produced from such glass.

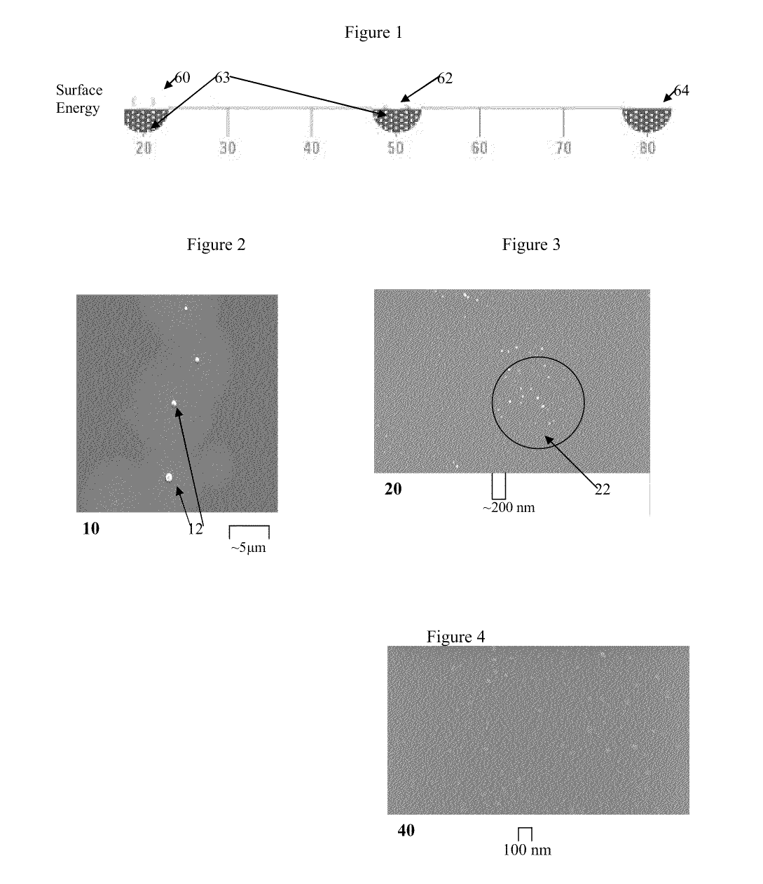

FIG. 1 illustrates the surface behavior of glass surfaces as a function of surface energy in dynes/cm. Surface energy increases as its value increases from left to right. For uncoated glass, at the condition represented by numeral 60 the energy is low (illustrated at 20 dynes/cm) and the glass exhibits strong hydrophobic properties and the coating material beads as illustrated. For an uncoated glass, at the condition represented by numeral 64 the surface energy is high (illustrated at 80 dynes/cm) and the glass exhibits hydrophilic properties and the coating material spreads out on the glass. For an uncoated glass, at the condition represented by numeral 62, the state of the glass surface is intermediate between that represented by numerals 60 and 64. At numeral 62 (surface energy illustrated as 50 dynes/cm) the coating material partially spreads out on the glass. In its pre-coating condition is desirable that the surface of the glass have hydrophilic properties. After coating it is desirable that the glass have hydrophobic properties. It has been determined that the difference between “sticky” and “non-sticky” behavior for glass surfaces is linked to the amount of surface water present. The higher the surface water content of glass surfaces the more likely it is that the surfaces will stick together. Consequently, when glass articles such as cover slips are used in automatic dispensing machines, the higher the water content of cover slip's surface the more likely jamming and glass breakage will occur. In accordance with the invention, after coating the surface properties of the coated glass should have a surface energy of less than 60 dynes/cm, preferable less than 50 dynes/cm, so as to avoid having coated glass sheets or cover slips made from coated glass sheet, stick to one another after prolonged exposure to moisture.

FIGS. 2 and 3 are SEM/EDX (scanning electron microscope/energy dispersive x-ray) images of commercially available anti-stick coated cover slips 10 and 20, respectively. As the images show, cover slips 10 and 20 have a residue on their surface. The cover slip 10 residue 12 is ˜1 μm 0.NaCl particles and the cover slip 20 residue 22 is an organic residue having finely dispersed 20 nm particles. It is these residues, which can or have absorbed water, that presently cause the cause the cover slip sticking problem. It has been found that coating the glass used to make cove slip with an aqueous suspension of an alkylpoly(alkoxy)silane will prevent cover slip sticking even after prolonged storage. The alkylpoly(alkoxy)silanes found useful in practicing the invention have the formula (R₁)ₓSi(OR₂)₄₋ₓ, where x=1-3, R₁ is a C₆-C₂₄ hydrocarbon (preferably an alkyl hydrocarbon) and R₂ is a C₁-C₃ hydrocarbon (preferably a C₁ hydrocarbon; that is, methyl). It is particularly desirable that the coating has resin particles in the size of 6-20 nm. In preferred embodiments the particle size is in the range of 6-15 nm

An exemplary glass used to make cover slips is the commercially available Corning 0211 glass (Corning Incorporated, Corning, N.Y.). Corning 0211 glass is a borosilicate glass containing potash (K₂CO₃), soda (Na₂CO₃), zinc oxide (ZnO), boron oxide (B₂O₃) and silicon dioxide (SiO₂) that has (in the metric units) a density of 2.53 g/cm³, a coefficient of thermal expansion (0-300° C. range) of 73.8×10⁻⁷/° C., a refractive index of 1.523 a transmission at 2200 nm of 92%. In the first part of making the cover clips the glass ingredients are batched and mixed; melted; drawn and/or otherwise formed into a continuous glass sheet having a final thickness in the range of 0.08-0.5 mm and a selected width; cooling to ambient temperature (approximately 18-30° C.); cutting the cooled glass into sheets or ribbons of selected length and width (for example without limitation, 40-41 cm wide and 40-74 cm long); and coating the glass with a selected colloidal alkylpoly(alkoxy)silane resin having a particle size in the range of 6-20 nm, preferably a particle size in the range of 6-15 nm. After the coating process the coating on the sheets is “dried” or “cured” by heating (for example without limitation, by infrared or microwave heating of the coating, or by heating in an oven to a temperature of approximately 250° C.) in order to effect the exchange between of the glass' OH groups and the silane OR groups to form SI—O—R bonds. For example

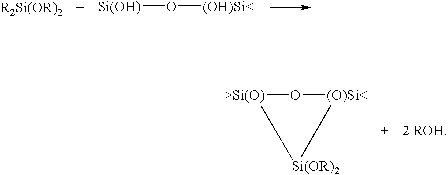

In one embodiment the glass is formed into a continuous sheet having a selected width and a thickness on the range of 0.08 to 0.5 mm and coated as described above, the coating dried, and then the continuous glass sheet is cut into individual sheets of selected size; for example without limitation, 40-41 cm wide and 40-74 cm long. These individual sheets are then cut to form cover slips having a selected length and width1, and a thickness in the range of 0.08 to 0.5 mm.

In a further embodiment, after forming as described above the continuous glass sheet was cooled to a temperature in the range of 70-180° C. (instead of being cooled to ambient temperature), was coated with a selected colloidal alkylpoly(alkoxy)silane resin at the temperature in the range of 70-180° C., and was then cooled to ambient temperature before it was cut into sheets of selected length and width. Coating at temperatures in the range of 70-180° C. facilitates bonding of the silane material (“drying” or “curing”) to the surface of the glass. The coating was carried out by applying the coating material, in the form of a solution and/or suspension, to the sheets using rollers, or by spraying or misting the coating onto the sheets using a spray or mist apparatus having nozzles of an appropriate size to allow the particles in the coating solution to pass through the nozzles. The coating by spraying, misting or use of rollers can be assisted by the use of infrared or microwave heating both during and after the coating process to maintain the temperature in the range of 70-180° C. When the coating was completed the glass coated glass was cut into large sheets which were then cut into cover slips having a selected length and width and a thickness in the range of 0.08 to 0.5 mm.

FIGS. 4 is an SEM/EDX image of cover slips 40 that have been coated with an alkylpoly(alkoxy)silane. Alkylpoly(alkoxy)silane are the preferred coating material because they can readily form, under relatively mild conditions, a covalent bond to the glass' surface hydroxyl species to form an Si—O—Si bonds whereas other materials do not form such a bond. In preferred embodiments the Alkylpoly(alkoxy)silane are applied as an aqueous solution/suspension using deionized water. The exemplary coating material that was used was DC2-1322 (Dow Corning, Midland, Mich.). DC2-1322, is a proprietary colloidal methylpoly(alkoxy)silane resin having therein colloidal particles of size of approximately 10 nm. DC2-1322 was obtained as a concentrated material containing approximately 6.5% active solids (solids that can bond to a glass surface) and was diluted in a water:DC2-1322 ratio of 250:1 to 1000:1 using deionized water before being applied to the glass. In FIG. 4, the “spots that appear in the photograph are differences in coating material density arising from spraying technique used to coat the glass and do not represent particulate matter. Although the coating in FIG. 4 contains ˜10 nm resin particles, the particles do not show up in the SEM/EDX image.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

We claim:

1. A method for making a coated, non-stick glass sheet, said method consisting of the steps:
preparing a potash, soda, zinc borosilicate glass mixture by combining potash, soda, zinc oxide and silica sand, and mixing same;
melting the batched material to form a glass melt;
forming the glass melt into a continuous glass sheet having a selected length, width and thickness
cooling the continuous sheet to ambient temperature; cutting the cooled continuous glass sheet into individual sheets;
coating the individual glass sheet with a selected colloidal alkylpoly(alkoxy)silane resin having a particle size in the range of 6-20 nm to thereby form a coated, non-stick glass sheet having a surface energy of less than 60 dynes/cm.

2. The method according to claim 1, wherein coating the individual glass sheets means coating using a method selected from the group consisting of roller application, dipping, spraying or misting.

3. The method according to claim 1, wherein coating the individual glass sheet with a selected colloidal alkylpoly(alkoxy)silane resin means coating using an aqueous suspension of colloidal silane particles having the formula (R₁)ₓSi(OR₂)₄₋ₓ, where x=1-3, R₁ is a C₆-C₂₄ hydrocarbon and R₂ is a C₁-C₃ hydrocarbon and particles in the range of 6-15 nm.

4. The method according to claim 3, wherein R₁ is a C₁₆-C₂₂ alkyl hydrocarbon and R₂ is a C₁ hydrocarbon.

5. The method according to claim 1, wherein coating with a selected colloidal alkylpoly(alkoxy)silane resin means coating with Dow Corning 2-1322.

6. A method for making a coated, non-stick glass cover slips, said method consisting of the steps:
preparing a potash, soda, zinc borosilicate glass mixture by combining potash, soda, zinc oxide and silica sand, and mixing same;
melting the batched material to form a glass melt;
forming the glass melt into a continuous glass sheet having a selected length, width and thickness
cooling the continuous sheet to a temperature in the range of 70-180° C. ambient temperature;
coating the continuous glass sheet with a selected colloidal alkylpoly(alkoxy)silane resin having a particle size in the range of 6-20 nm, while maintaining the temperature of the continuous glass sheet in the range of 70-180° C., to thereby form a coated, non-stick continuous glass sheet having a surface energy of less than 60 dynes/cm;
cooling the coated continuous glass sheet to ambient temperature;
cutting the cooled coated continuous glass sheet into individual sheets; and
cutting the individual glass sheets into individual cover slips of selected of selected length and width and thickness in the range of 0.076 mm to 0.60 mm.

7. The method according to claim 6, wherein coating the individual glass sheet with a selected alkylpoly(alkoxy)silane resin means coating using an aqueous suspension of a colloidal silane resin having the formula (R₁)ₓSi(OR₂)₄₋ₓ, where x=1-3, R₁ is a C₆-C₂₄ hydrocarbon and R₂ is a C₁-C₃ hydrocarbon and particles in the range of 6-15 nm.

8. The method according to claim 7, wherein R₁ is a C₁₆-C₂₂ alkyl hydrocarbon and R₂ is a C₁-C₂ alkyl hydrocarbon.

9. The method according to claim 6, wherein coating with a selected colloidal alkylpoly(alkoxy)silane resin means coating with Dow Corning 2-1322.

10. A no-stick cover slip, said cover slip consisting of potash, soda, zinc borosilicate glass substrate having a coating of a selected alkylpoly(alkoxy)silane containing colloidal particles of said silane therein, said silane have the formula (R₁)ₓSi(OR₂)₄₋ₓ, where x=1-3, R₁ is a C₆-C₂₄ hydrocarbon and R₂ is a C₁-C₃ hydrocarbon; and particles in the range of 6-15 nm; said coated cover slip having a surface energy of less than 60 dynes/cm.

11. The cover slip according to claim 9, wherein said cover slip coating is DC2-1322.

12. The cover slip according to claim 10, wherein said cover slip has a length and a width and a thickness in the range of 0.076 mm to 0.60 mm.
